(19) United States
(12) Patent Application Publication
(10) Pub. No.: US 2011/0159294 A1
(43) Pub. Date: Jun. 30, 2011

(54) ATTACH FILM COMPOSITION FOR SEMICONDUCTOR ASSEMBLY AND ATTACH FILM USING THE SAME

(76) Inventors: Gyu Seok Song, Uiwang-si (KR); Jong Pil Ho, Uiwang-si (KR); Jae Won Choi, Uiwang-si (KR); Su Mi Im, Uiwang-si (KR); Ki Tae Song, Uiwang-si (KR)

(21) Appl. No.: 12/981,110

(22) Filed: Dec. 29, 2010

(30) Foreign Application Priority Data
Dec. 30, 2009 (KR) 10-2009-0134713

(51) Int. Cl. C08L 63/02; C08K 3/36; B32B 27/38

(52) U.S. Cl. 428/414; 523/400; 523/466

(57) ABSTRACT

An attach film composition for semiconductor assembly includes a polymer binder, an epoxy resin, a phenolic epoxy curing agent, a curing accelerator, a silane coupling agent, and an inorganic filler. The attach film composition may have an exothermic peak start temperature of about 300° C. or more in curing, and a melt viscosity of about 1.0×10⁵ to about 5.0×10⁶ Poise at 175° C. after curing at 150° C. for 1 hour and a melt viscosity of about 1.0×10⁵ to about 5.0×10⁶ Poise at 175° C. after curing at 175° C. for 2 hours.

### BACKGROUND

1. Field

Embodiments relate to an attach film composition for semiconductor assembly and an attach film using the same.

2. Description of the Related Art

With recent advances in micro-electronic technology and development of electronic components, a rapid increase in demand for various kinds of highly integrated, high performance semiconductor packages has led to development of highly reliable packages.

A chip scale package (CSP) is a new mount technology developed to keep pace with increasing miniaturization and integration of semiconductor chips. In the CSP, the size of a chip carried thereon is substantially the same as the size of the package. A multi chip package (MCP) is a new, state of the art package. The MCP includes a plurality of chips stacked one above the other and can mount much more chips therein than other existing packages.

### SUMMARY

An embodiment is directed to an attach film composition for semiconductor assembly, the composition including a polymer binder, an epoxy resin, a phenolic epoxy curing agent, a curing accelerator, a silane coupling agent, and an inorganic filler. The attach film composition may have an exothermic peak start temperature of about 300° C. or more in curing, and a melt viscosity of about 1.0×10⁵ to about 5.0×10⁶ Poise at 175° C. after curing at 150° C. for 1 hour and a melt viscosity of about 1.0×10⁵ to about 5.0×10⁶ Poise at 175° C. after curing at 175° C. for 2 hours.

The attach film composition may include, based on 100 parts by weight of the polymer binder, about 5 to about 30 parts by weight of the epoxy resin, about 1 to about 30 parts by weight of the phenolic epoxy curing agent, about 0.01 to about 10 parts by weight of the curing accelerator, about 0.01 to about 10 parts by weight of the silane coupling agent, and about 0.5 to about 20 parts by weight of the inorganic filler.

The polymer binder may have a glass transition temperature of about −10° C. to about +20° C.

The polymer binder may have a weight average molecular weight of about 50,000 to about 500,000 g/mol.

The polymer binder may include at least one of an epoxy group-containing (meth)acrylate copolymer containing glycidyl (meth)acrylate, a (meth)acryl resin, a polyimide resin, a polystyrene resin, a polyethylene resin, a polyester resin, a polyamide resin, a butadiene rubber, an acryl rubber, a urethane resin, a polyphenylene ether resin, a polyetherimide resin, a phenoxy resin, a polycarbonate resin, a polyphenylene ether resin, and a modified polyphenylene ether resin.

The epoxy resin may include at least one of a bisphenol-based epoxy resin, a phenol novolac-based epoxy resin, a cresol novolac-based epoxy resin, a polyfunctional epoxy resin, an amine-based epoxy resin, a heterocyclic epoxy resin, a substituted epoxy resin, a naphthol-based epoxy resin, and derivatives thereof.

The phenolic epoxy curing agent may include a phenol-p-xyleneglycoldimethylether polycondensate-based curing agent.

The inorganic filler may include at least one of gold in powder form, silver in powder form, copper in powder form, nickel in powder form, alumina, aluminum hydroxide, magnesium hydroxide, calcium carbonate, magnesium carbonate, calcium silicate, magnesium silicate, calcium oxide, magnesium oxide, aluminum nitride, silica, boron nitride, titanium dioxide, glass, ferrite, and ceramic.

The curing accelerator may include at least one of a melamine-based curing accelerator, an imidazole-based curing accelerator, and a triphenylphosphine-based curing accelerator.

The silane coupling agent may include at least one of an epoxy-containing silane coupling agent, an amine group-containing silane agent, a mercapto-containing silane agent, and an isocyanate-containing silane agent.

The silane coupling agent may include the epoxy-containing silane coupling agent, the epoxy-containing silane coupling agent including at least one of 2-(3,4-epoxycyclohexyl)-ethyltrimethoxysilane, 3-glycidoxytrimethoxysilane, and 3-glycidoxypropyl triethoxysilane.

The silane coupling agent may include the amine group-containing silane agent, the amine group-containing silane agent including at least one of N-2(aminoethyl)-3-aminopropyl methyldimethoxysilane, N-2(aminoethyl)-3-aminopropyltrimethoxysilane, N-2(aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine, and N-phenyl-3-aminopropyltrimethoxysilane.

The silane coupling agent may include the mercapto-containing silane agent, the mercapto-containing silane agent including at least one of 3-mercaptopropylmethyl dimethoxysilane and 3-mercaptopropyltriethoxysilane.

The silane coupling agent may include the isocyanate-containing silane agent, the isocyanate-containing silane agent including 3-isocyanate propyltriethoxysilane.

Another embodiment is directed to an attach film for semiconductor assembly formed of an attach film composition according to an embodiment.

Another embodiment is directed to an attach tape for semiconductor packaging, including a base film, a UV curable adhesive film, the attach film according to an embodiment, and a protective film.

Another embodiment is directed to an attach film composition for semiconductor assembly, the composition including an acrylic polymer binder, the acrylic polymer binder having a glass transition temperature of about −10° C. to about +20° C. and having a weight average molecular weight of about 50,000 to about 500,000 g/mol, a bisphenol-A-based epoxy resin having a molecular weight of about 10,000 or less, a polymeric curing agent including a polymeric backbone corresponding to a polymer of phenol with 1,4-bis(methoxymethyl)benzene, a curing accelerator, a silane coupling agent, and an inorganic filler.

### BRIEF DESCRIPTION OF THE DRAWING

The above and other features and advantages will become more apparent to those of skill in the art by describing in detail example embodiments with reference to the attached drawings, in which:

FIG. 1 illustrates curves of DCS variation of an attach film prepared in Example 1 before curing, after curing at 150° C. for 1 hr, and after curing at 175° C. for 2 hr, respectively.

### DETAILED DESCRIPTION

Korean Patent Application No. 10-2009-0134713, filed on Dec. 30, 2009, in the Korean Intellectual Property Office, and entitled: “Attach Film Composition for Semiconductor Assembly and Attach Film Using the Same,” is incorporated by reference herein in its entirety.

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey the scope of the invention to those skilled in the art.

It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Embodiments relate to an attach film composition for semiconductor assembly. In an example embodiment, the film composition includes a polymer binder, an epoxy resin, a phenolic epoxy curing agent, a curing accelerator, a silane coupling agent, and an inorganic filler, and has an exothermic peak start temperature of about 300° C. or more in curing, and a melt viscosity of about 1.0×10⁵ to 5.0×10⁶ Poise at 175° C. after curing at 150° C. for 1 hr and a melt viscosity of about 1.0×10⁵ to 5.0×10⁶ Poise at 175° C. after curing at 175° C. for 2 hr.

In this example embodiment, the attach film composition includes the polymer binder, the epoxy resin, the phenolic epoxy curing agent, the curing accelerator, the silane coupling agent, and the inorganic filler. Further, the attach film composition is regulated to have an exothermic peak start temperature of about 300° C. or more in curing reaction, preferably about 320 to 340° C. to decrease curing speed, and has a melt viscosity of about 1.0×10⁵ to 5.0×10⁶ Poise at 175° C. after curing at 150° C. for 1 hour and a melt viscosity of about 1.0×10⁵ to 5.0×10⁶ Poise at 175° C. after curing at 175° C. for 2 hours. According to this embodiment, the attach film composition may provide desirable characteristics by providing improved adhesion to a base interface through regulation of the curing speed and viscosity to facilitate elimination of voids and to secure high reliability. The attach film composition may also provide desirable characteristics by maintaining suitable melt viscosity to have suitable liquidity, thereby preventing movement during wire bonding.

The attach film composition may include about 5 to 30 parts by weight of the epoxy resin, about 1 to 30 parts by weight of the phenolic epoxy curing agent, about 0.01 to 10 parts by weight of the curing accelerator, about 0.01 to 10 parts by weight of the silane coupling agent, and about 0.5 to 20 parts by weight of the inorganic filler, based on 100 parts by weight of the polymer binder.

Each of the above components will now be described in more detail.

Polymer Binder

The polymer binder preferably has a glass transition temperature of about −10° C. to about +20° C., and more preferably about −5 to about +15° C., to regulate exothermic peak start temperature during curing and maintain suitable viscosity after curing. Within this range, the polymer binder may secure suitable levels of void removal ability and thermal resistance at the same time. Further, the polymer binder may have a weight average molecular weight of about 50,000 to about 500,000 g/mol to facilitate regulation of curing speed and viscosity after curing.

Examples of the polymer binder include (meth)acryl resins, polyimide resins, polystyrene resins, polyethylene resins, polyester resins, polyamide resins, butadiene rubbers, acryl rubbers, urethane resins, polyphenylene ether resins, polyetherimide resins, phenoxy resins, polycarbonate resins, polyphenylene ether resins, modified polyphenylene ether resins, and epoxy group-containing (meth)acrylate copolymers containing glycidyl(meth)acrylate.

The binder resins may be used alone or in a combination of two or more thereof.

Still more preferably, as the binder resin for the film composition, an acryl resin having a glass transition temperature of about −10 to +20° C. and a weight average molecular weight of about 50,000 to 500,000 g/mol is used alone or in combination with other polymer binders.

Epoxy Resin

A suitable epoxy resin that exhibits curing and adhesive properties may have at least one functional group, more preferably, two or more functional groups.

Examples of the epoxy resin include bisphenol-based epoxy resins, phenol novolac-based epoxy resins, cresol novolac-based epoxy resins, polyfunctional epoxy resins, amine-based epoxy resins, heterocyclic epoxy resins, substituted epoxy resins, naphthol-based epoxy resins, and derivatives thereof. Advantageously, bisphenol-based epoxy resins may be used.

Examples of commercially available bisphenol-based epoxy resins include: YD-017H, YD-020, YD020-L, YD-014, YD-014ER, YD-013K, YD-019K, YD-019, YD-017R, YD-017, YD-012, YD-011H, YD-011S, YD-011, YD-128, YDF-2004, YDF-2001 (Kukdo Chemical Co., Ltd.), etc.

Examples of commercially available phenol novolac-based epoxy resins include: Chepicoat 152, Epicoat 154 (Yuka Shell Epoxy Co., Ltd.); EPPN-201 (Nippon Kayaku Co., Ltd.); DN-483 (Dow Chemical Company); YDPN-641, YDPN-638A80, YDPN-638, YDPN-637, YDPN-644, YDPN-631 (Kukdo Chemical Co., Ltd.), etc.

Examples of commercially available o-cresol novolac-based epoxy resins include: YDCN-500-1P, YDCN-500-2P, YDCN-500-4P, YDCN-500-5P, YDCN-500-7P, YDCN-500-8P, YDCN-500-10P, YDCN-500-80P, YDCN-500-80PCA60, YDCN-500-80PBC60, YDCN-500-90P, YDCN-500-90PA75 (Kukdo Chemical Co., Ltd.); EOCN-102S, EOCN-103S, EOCN-1045, EOCN-1012, EOCN-1025, EOCN-1027 (Nippon Kayaku Co., Ltd.); YDCN-701, YDCN-702, YDCN-703, YDCN-704 (Tohto Kagaku Co., Ltd.); Epiclon N-665-EXP (Dainippon Ink and Chemicals, Inc.), etc.

Examples of commercially available bisphenol-based novolac epoxy resins include KBPN-110, KBPN-120, KBPN-115 (Kukdo Chemical Co., Ltd.), etc.

Examples of commercially available polyfunctional epoxy resins include: Epon 1031S (Yuka Shell Epoxy Co., Ltd.); Araldite 0163 (Ciba Specialty Chemicals); Detachol EX-611, Detachol EX-614, Detachol EX-614B, Detachol EX-622, Detachol EX-611, Detachol EX-614, Detachol EX-614B, Detachol EX-622, Detachol EX-512, Detachol EX-521, Detachol EX-421, Detachol EX-411, Detachol EX-321 (NAGA Celsius Temperature Kasei Co., Ltd.); EP-5200R, KD-1012, EP-5100R, KD-1011, KDT-4400A70, KDT-4400, YH-434L, YH-434, YH-300 (Kukdo Chemical Co., Ltd.), etc.

Examples of commercially available amine-based epoxy resins include: Epicoat 604 (Yuka Shell Epoxy Co., Ltd.); YH-434 (Tohto Kagaku Co., Ltd.); TETRAD-X and TETRAD-C (Mitsubishi Gas Chemical Company Inc.); ELM-120 (Sumitomo Chemical Industry Co., Ltd.), etc.

An example of a commercially available heterocyclic epoxy resin is PT-810 (Ciba Specialty Chemicals).

Examples of commercially available substituted epoxy resins include: ERL-4234, ERL-4299, ERL-4221, ERL-4206, etc. (UCC Co., Ltd.).

Examples of commercially available naphthol-based epoxy resins include: Epiclon HP-4032, Epiclon HP-4032D, Epiclon HP-4700, and Epiclon HP-4701 (Dainippon Ink and Chemicals, Inc.).

The epoxy resins may be used alone or in a combination of two or more thereof.

The epoxy resin is preferably present in the composition in an amount of about 5 to about 30 parts by weight, more preferably, about 10 to about 20 parts by weight based on 100 parts by weight of the polymer binder. Within this range, the attach film composition may secure high reliability and tensile strength.

Phenolic Epoxy Curing Agent

A suitable commercially available phenolic epoxy curing agent that can slow curing speed may be used. Advantageously, xyloc-based curing agents may be used, e.g., a phenyl-type phenol aralkyl resin, or phenol-p-xyleneglycoldimethylether polycondensate. Suitable phenolic epoxy curing agents may have two or more phenolic hydroxyl groups per molecule. Examples of suitable phenolic epoxy curing agents include bisphenol resins such as bisphenol A, bisphenol F and bisphenol S resins; phenol novolac resins; bisphenol A novolac resins; cresol novolac resins; and biphenyl resins, all of which are highly resistant to electrolytic corrosion upon moisture absorption and different amounts of which may be used.

Examples of commercially available phenolic epoxy curing agents include: simple curable phenolic resins, such as H-1, H-4, HF-1M, HF-3M, HF-4M, and HF-45 (Meiwa Plastic Industries Co., Ltd.); para-xylene-based resins such as MEH-78004S, MEF-7800SS, MEH-7800S, MEH-7800M, MEH-7800H, MEH-7800HH, and MEH-78003H (Meiwa Plastic Industries Co., Ltd.), and KPH-F3065 (KOLON Chemical Co., Ltd.); biphenyl-based resins such as MEH-7851SS, MEH-7851S, MEH-7851M, MEH-7851H, MEH-78513H, and MEH-78514H (Meiwa Plastic Industries Co., Ltd.), and KPH-F4500 (KOLON Chemical Co., Ltd.); and triphenylmethyl-based resins such as MEH-7500, MEH-75003S, MEH-7500SS, MEH-75005, and MEH-7500H (Meiwa Plastic Industries Co., Ltd.).

The phenolic epoxy curing agents may be used alone or in a combination of two or more thereof.

The phenolic epoxy curing agent is preferably present in the composition in an amount of about 1 to about 30 parts by weight, more preferably about 10 to about 20 parts by weight, based on 100 parts by weight of the polymer binder. Within this range, the attach film composition may provide improved reliability and may secure suitable levels of void removal ability and thermal resistance at a suitable curing speed.

Curing Accelerator

The curing accelerator may be used to reduce curing time to allow the epoxy resin to be completely cured during a semiconductor assembly process. Suitable curing accelerators include melamine-based, imidazole-based, and triphenylphosphine-based curing accelerators.

Examples of commercially available imidazole-based curing accelerators include: PN-23, PN-40 (Ajinomoto Co., Ltd.); 2P4MZ, 2MA-OK, 2MAOK-PW, 2P4 MHZ (Sikoku Kagaku Co., Ltd.); and TPP-K, TPP-MK (HOKKO Chemical Industry Co., Ltd.).

The curing accelerators may be used alone or in a combination of two or more thereof.

The curing accelerator may be present in the composition in an amount of about 0.01 to about 10 parts by weight, preferably about 0.02 to about 5 parts by weight, based on 100 parts by weight of the polymer binder. Within this range, the epoxy resin may be suitably crosslinked, thereby securing both thermal resistance and storage stability.

Silane Coupling Agent

The silane coupling agent may be used as an adhesion promoter enhancing adhesion between a surface of an inorganic material, such as silica, and an organic material through chemical coupling therebetween during formulation of the composition.

A silane coupling agent such as an epoxy-containing silane coupling agent, amine group-containing silane coupling agent, mercapto-containing silane coupling agent, or an isocyanate-containing silane agent, may be used.

Examples of the epoxy-containing silane coupling agents include 2-(3,4-epoxycyclohexyl)-ethyltrimethoxysilane, 3-glycidoxytrimethoxysilane, and 3-glycidoxypropyl triethoxysilane.

Examples of the amine group-containing silane agents include N-2(aminoethyl)-3-aminopropylmethyldimethoxysilane, N-2(aminoethyl)-3-aminopropyltrimethoxysilane, N-2(aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine, and N-phenyl-3-aminopropyltrimethoxysilane.

Examples of mercapto-containing silane agents include 3-mercaptopropylmethyl dimethoxysilane and 3-mercaptopropyltriethoxysilane.

An example of the isocyanate-containing silane agent is 3-isocyanate propyltriethoxysilane.

The silane coupling agents may be used alone or in a combination of two or more thereof.

The coupling agent may be present in the composition in an amount of about 0.01 to about 10 parts by weight, preferably about 0.2 to about 5 parts by weight, based on 100 parts by weight of the polymer binder. Within this range, the attach film composition may provide improved attach reliability.

Inorganic Filler

The inorganic filler may be used to improve thermal resistance and dimensional stability to the attach film. Examples of the inorganic fillers include metals, such as gold, silver, copper and nickel in powder form; and nonmetals, such as alumina, aluminum hydroxide, magnesium hydroxide, calcium carbonate, magnesium carbonate, calcium silicate, magnesium silicate, calcium oxide, magnesium oxide, aluminum oxide, aluminum nitride, silica, boron nitride, titanium dioxide, glass, ferrite, ceramics, etc. In an implementation, silica may be used as the filler.

There is no particular restriction as to the shape and size of the inorganic filler. In an embodiment, spherical silica or amorphous silica is used as the filler. In this case, the filler preferably has a particle size of about 5 nm to 20 μm, and more preferably about 15 nm to 2 μm.

The inorganic filler is preferably present in the composition in an amount of about 0.5 to 20 parts by weight, and more preferably about 5 to 15 parts by weight, based on 100 parts by weight of the polymer binder. Within this range, the attach film composition may provide improved thermal resistance without deterioration in adhesion to an attach target.

Organic Solvent

The attach film composition may further include an organic solvent. The organic solvent may be used to reduce the viscosity of the semiconductor attach film composition, thereby facilitating fabrication of the attach film. Applicable examples of the organic solvents include toluene, xylene, propylene glycol monomethylether acetate, benzene, acetone, methylethylketone, tetrahydrofuran, dimethylformamide, and cyclohexanone.

The organic solvent may be present in an amount of about 40 to about 500 parts by weight, preferably about 50 to about 200 parts by weight, based on 100 parts by weight of the polymer binder.

Ion Scavenger

An ion scavenger may be used for trapping impurities while ensuring that absorbed moisture does not deteriorate insulation.

Examples of the ion scavenger include triazine thiol compounds, zirconium-based compounds, antimony bismuth compounds, and magnesium aluminum-based compounds.

The ion scavenger may be present in the composition in an amount of about 0.01 to about 10 parts by weight, preferably about 0.05 to about 5 parts by weight, based on 100 parts by weight of the polymer binder. Within this range, the attach film composition may provide reliability in adsorption of ionic impurities and insulation without deteriorating economic feasibility.

Embodiments also relate to an attach film for semiconductor assembly, the attach film being formed of the attach film composition according to an embodiment.

The attach film formed of the composition according to an embodiment may exhibit improved adhesion to the base interface due to high exothermic peak start temperature during curing and have suitable melt viscosity after curing to exhibit excellent ability in eliminating voids. Elimination of voids may thereby improve reliability and wire bonding stability.

Embodiments also relate to an attach tape for semiconductor packaging that includes the attach film according to an embodiment.

In an example embodiment, the attach tape for semiconductor packaging is composed of a base film, a UV curable adhesive film, the attach film and a protective film, which are sequentially stacked in the stated sequence.

The base film, the adhesive film, the attach film and the protective film constituting the attach tape for semiconductor packaging will now be described in more detail.

Base Film

The base film may be the same as a conventional tape used for a back grinding process. Various kinds of plastic films may be used as the base film of the tape for the back-grinding process. Inter alia, a thermoplastic expandable plastic film is used for a general base film.

A wafer having a circuit pattern is susceptible to damage or breakage due to generation of cracks upon exposure to physical impact during back grinding. Therefore, the thermoplastic expandable plastic film is used as the base film to protect the wafer from impact during the back-grinding process through absorption and relief of impact.

The base film may be not only expandable, but also transparent to UV light. In particular, a photocurable adhesive layer may contain a UV curable adhesive composition. Thus, it is desirable for the base film to exhibit good transparency to UV light at a frequency at which the adhesive composition is cured. Thus, the base film may be substantially free of UV light absorbents.

It is desirable for the base film to be chemically stable. Although the base film is prepared in consideration of heavy impact applied during the back-grinding process, it is preferable that the base film have chemical stability since a final polishing step may be performed using CMP slurries. In general, polymeric compounds, such as polyolefins, are chemically stable and may be suitably used as the base film.

Examples of polymer films that may be used as the base film include polyolefin films, such as polyethylene, polypropylene, ethylene/propylene copolymers, polybutylene-1, ethylene/vinyl acetate copolymers, polyethylene/styrene-butadiene rubber blends, polyvinylchloride films, and the like. Further, the base film may be formed of plastics, such as polyethylene terephthalate, polycarbonate, poly(methyl methacrylate), and the like; thermoplastic elastomers, such as polyurethane, polyamide-polyol copolymers, and the like; and mixtures thereof.

The base film may be formed by an extrusion process or a blowing process after blending and melting polyolefin chips. Thermal resistance and mechanical properties of the base film are determined depending on the kind of chips blended with each other. The base film may be subjected to surface modification to improve adhesion to the adhesive layer.

The base film may have a thickness of about 30 to about 300 μm in terms of workability, UV transparency, and the like. Within this range, the base film may not suffer from thermal deformation during UV irradiation and may sufficiently relieve impact during the back-grinding process. Furthermore, within this range, a single roll of complete film product may have a suitable ratio of length to thickness to prevent frequent replacement of the roll, thus consuming less time and providing an advantage in terms of cost. The base film may have a thickness of about 50 to about 200 μm in order to ensure that the base film sufficiently contacts an irregular surface of a wafer on which bumps are formed.

Adhesive Film

In an implementation, the adhesive film is composed of a photocurable adhesive layer, e.g., a UV-curable layer. Before UV irradiation, such an adhesive layer prevents damage of a wafer by vibration or movement during the back-grinding process and prevents infiltration of chemical components, such as CMP slurry components, into interfaces between the respective layers by strongly supporting an insulation attach layer thereon and the wafer via strong tack. Further, after UV irradiation, such an adhesive layer allows easy release of the base film from the wafer, to which the insulation attach layer is attached by a reel type attach tape, since the coating shrinks by an increase in adhesion caused by a crosslinking reaction and is significantly reduced in adhesion at an interface with the insulation attach layer due to such shrinkage.

Advantageously, the photocurable adhesive layer of the attach film is composed of a UV-curable composition. In a general back-grinding tape, an adhesive layer composed of the UV non-curable composition has relatively low adhesive strength before UV irradiation, so that the adhesive layer can be easily peeled from the interface between the adhesive layer and the wafer by the reel-type attach tape even without UV irradiation. However, for a WSP tape, peeling of the tape is achieved between the adhesive layer and the insulation attach layer, which is an organic interface. In this case, the adhesive layer composed of the non-UV curable compound may not allow complete separation of the wafer using the reel-type attach tape. Therefore, the photocurable adhesive layer may be composed of a composition in which a UV curable carbon-carbon double bond is added to the side chain of the binder, instead of a mixture composition. Such a composition, which behaves as a single molecule layer through addition of a low molecular weight material having a carbon-carbon double bond at a side chain of an adhesive resin through chemical reaction, is referred to as an embedded type adhesive composition.

In an embodiment, the embedded type adhesive binder has a molecular weight of about 100,000 to about 1,000,000 g/mol, preferably about 300,000 to about 800,000 g/mol. Here, the embedded type adhesive binder may be prepared by adding a low-molecular weight compound having the carbon-carbon double bond at a side chain of a copolymerized binder through urethane reaction, in which a low molecular weight compound having a terminal isocyanate group is used as the low-molecular weight compound having the carbon-carbon double bond. The UV curable adhesive composition may be prepared by mixing the prepared adhesive binder with a heat curing agent, a photo-initiator, and the like.

A suitable heat curing agent that can be cured through reaction with a functional group provided to the side chain of the adhesive binder may be used for the adhesive composition. If the functional group provided to the side chain is a carboxyl group, an epoxy curing agent may be used as the heat curing agent, and if the functional group provided to the side chain is a hydroxyl group, an isocyanate-based curing agent may be used. A melamine-based curing agent may also serve as the heat curing agent. Additionally, a mixture of two or more of the epoxy-based curing agent, the isocyanate-based curing agent and the melamine-based curing agent may be used.

A photo-initiator, such as a ketone-based photo-initiator and an acetophenone-based photo-initiator, that can generate a radical upon cleavage of a molecular bond thereof upon UV irradiation may be used for the adhesive composition. When the photo-initiator is added to the adhesive composition, the carbon-carbon double bond in the side chain of the adhesive binder may undergoes a crosslinking reaction with the radical such that the glass transition temperature of the adhesive layer increases by the cross-linking reaction, thereby reducing tack of the adhesive layer. When the adhesive layer loses tackiness, little force is needed to peel the adhesive layer from the insulation attach layer thereon.

As a method for forming the adhesive layer on the base film, direct coating or transfer coating may be used. In the transfer coating, the adhesive layer is transferred from a release film to the base film after being coated and dried on the release film. A suitable coating method, such as bar coating, gravure coating, comma coating, reverse-roll coating, applicator coating, spray coating, and the like that can form a coating layer may be used when forming the adhesive layer on the base film.

Attach Film

The attach film is formed of the attach film composition for semiconductor assembly as described above and constitutes an insulation attach layer.

In the attach tape for semiconductor packaging, the photocurable adhesive layer may be coated on a polyolefin-based base film, followed by stacking the insulation attach layer on the photocurable adhesive layer. The insulation attach layer is an attach layer to be brought into direct contact with the surface of the wafer. In the WSP, it is desirable for the insulation attach layer to be stacked on the surface of the wafer, which is highly irregular due to the formation of bumps or the like thereon, without a void, and then to strongly bond both upper and lower sides of chips therein through die attachment.

The insulation attach layer may be used as an attach material for finally attaching both upper and lower sides of chips in the attach material. Thus, it is desirable for the insulation attach layer to have properties satisfying semiconductor packaging-level reliability and processability for packaging. For example, it is desirable that the irregular surface of the wafer be filled with the insulation attach layer without void occurrence during a mounting process to prevent the occurrence of chipping or cracking during a dicing process and deterioration in reliability due to swelling after the die-attaching process. The insulation attach layer may be attached at about 60° C. to the surface of the wafer, on which a circuit pattern is formed to create bumps thereon.

As for the adhesive layer, a suitable coating method that can form a uniform insulation attach layer may be used to form the attach layer. The insulation attach layer may have a coating thickness of 2 to 30 μm. Within this range, the insulation attach layer provides suitable attach strength between the upper and lower sides of the chips and is advantageous in view of the current trend towards light, thin and small semiconductor packages.

Protective Film

A suitable film that can protect the insulation attach layer from foreign matter or external impact, and a film used as a running film for coating the insulation attach layer may be used as the protective film.

A semiconductor packaging process may be carried out with the protective film removed from the tape. Thus, an easily releasable film is advantageously used and a polyethylene terephthalate film may be used as the protective film. The protective film may be subjected to surface modification using a polydimethylsiloxane release agent or a fluorine-based release agent to provide releasing properties to the protective film.

The following Examples and Comparative Examples are provided in order to set forth particular details of one or more embodiments. However, it will be understood that the embodiments are not limited to the particular details described. Further, the Comparative Examples are set forth to highlight certain characteristics of certain embodiments, and are not to be construed as either limiting the scope of the invention as exemplified in the Examples or as necessarily being outside the scope of the invention in every respect.

### EXAMPLES

### Preparation Example 1

### Preparation of Photocurable Adhesive Composition (for Adhesive Film)

240 g of ethyl acetate and 120 g of toluene were added to a 2L 4-neck flask equipped with a reflux condenser and a thermometer at one side thereof and with a dropping funnel at the other side thereof. After heating this solution to 60° C., 51 g of methylmethacrylate, 54 g of butylacrylate monomer, 285 g of 2-ethylhexylacrylate, 180 g of 2-hydroxyethylmethacrylate, 30 g of acrylic acid, and 3.9 g of benzoylperoxide were mixed, placed in the dropping funnel and added dropwise to the solution at 60 to 70° C. over 3 hours. Here, the mixture was added dropwise to the solution while stirring at 250 rpm. After adding the mixture, the reactants were aged for 3 hours at the same temperature, and then 60 g of methoxypropylacetate and 0.2 g of azobisisobutyronitrile was added to the reactants in the flask, which in turn was left in this state for 4 hours, followed by measuring the viscosity and solid content and completing polymerization. The polymerized binder resin was adjusted to a viscosity of 10,000 to 15,000 cps and a solid content of 40%. Then, 45 g of glycidylmethacrylate was added to the prepared acrylic adhesive binder and reacted therewith at 50° C. for 1 hr to prepare an embedded type adhesive binder. Then, 2 g of a heat curing agent (AK-75, Aekyung Chemical Co., Ltd., Korea) and 1 g of photo-initiator (IC-184, Ciba-Geigy Co., Ltd., JP) were added to 100 g of the prepared adhesive binder, thereby preparing a UV curable adhesive composition.

### Preparation Examples 2 to 5

### Preparation of Insulation Attach Composition (for Attach Film)

Each of the insulation attach compositions for attach films was prepared according to the compositions listed in Table 1.

TABLE 1

| | | Preparation | Preparation | Preparation |
|---|---|---|---|---|
| | Preparation | Example 3 | Example 4 | Example 5 |
| | Example 2 | (Comparative | (Comparative | (Comparative |
| Component | (Example 1) | Example 1) | Example 2) | Example 3) |
| Binder resin | acrylic binder¹ | acrylic binder¹ | acrylic binder² | acrylic binder³ |
| | 300 g | 300 g | 220 g | 350 g |
| Epoxy resin | BPA resin | cresol novolac resin | cresol novolac resin | cresol novolac resin |
| | 45 g | 75 g | 110 g | 20 g |
| Curing | xyloc-based | xyloc-based | cresol | cresol |
| agent | curing agent | curing agent | novolac-based | novolac-based |
| | 45 g | 75 g | curing agent | curing agent |
| | | | 110 g | 110 g |
| Filler | round silica | fumed silica | fumed silica | round silica |
| | 30 g | 3 g | 3 g | 30 g |
| Curing | imidazole- | imidazole-based | imidazole-based | imidazole-based |
| accelerator | based | 0.5 g | 1 g | 1.5 g |
| | 0.1 g | | | |
| Silane | amino silane | amino silane | amino silane | amino silane |
| coupling | coupling agent | coupling agent | coupling agent | coupling agent |
| agent | 1 g | 1 g | 1 g | 1 g |

Notes:
¹acrylic binder molecular weight 350K;
²acrylic binder molecular weight 900K;
³acrylic binder molecular weight 1200K

### Preparation Example 2

300 g of an acryl resin (SG-80H, weight average molecular weight of 350,000, glass transition temperature of 12° C., Nagase ChemTech Co., Ltd.), 45 g of a BPA (bisphenol A)-based epoxy resin (YD-128, molecular weight of 10,000 or less, Kukdo Chemical Co., Ltd.), 45 g of a xyloc-based curing agent (MEH7800C, Meiwa Plastic Industries Co., Ltd.), 0.1 g of an imidazole-based curing accelerator (2P4MZ, Sikoku Chemical Co., Ltd.), 1 g of an amino silane coupling agent (KBM-573, Shin Estu Chemical Co., Ltd.), and 30 g of a round silica filler (PLV-6XS, Tatsumori) were mixed and in turn subjected to primary dispersion at 700 rpm for 2 hours, followed by milling, thereby preparing an attach composition.

### Preparation Example 3

300 g of an acryl resin (SG-80H, weight average molecular weight of 350,000, glass transition temperature of 12° C., Nagase ChemTech Co., Ltd.), 75 g of a cresol novolac-based epoxy resin (YDCN-500-90P, molecular weight of 10,000 or less, Kukdo Chemical Co., Ltd.), 75 g of a xyloc-based curing agent (MEH7800C, Meiwa Plastic Industries Co., Ltd.), 0.5 g of an imidazole-based curing accelerator (2P4MZ, Sikoku Chemical Co., Ltd.), 1 g of an amino silane coupling agent (KBM-573, Shin Estu Chemical Co., Ltd.), and 3 g of a fumed silica filler (R-972, Degussa) were mixed and in turn subjected to primary dispersion at 700 rpm for 2 hours, followed by milling, thereby preparing an attach composition.

### Preparation Example 4

220 g of an acryl resin (SG-70L, weight average molecular weight of 900,000, glass transition temperature of −13° C., Nagase ChemTech Co., Ltd.), 110 g of a cresol novolac-based epoxy resin (YDCN-500-1P, molecular weight of 10,000 or less, Kukdo Chemical Co., Ltd.), 110 g of a cresol novolac-based curing agent (MY721, Huntsman), 1 g of an imidazole-based curing accelerator (2P4MZ, Sikoku Chemical Co., Ltd.), 1 g of an amino silane coupling agent (KBM-573, Shin Estu Chemical Co., Ltd.), and 3 g of a fumed silica filler (R-972, Degussa) were mixed and in turn subjected to primary dispersion at 700 rpm for 2 hours, followed by milling, thereby preparing an attach composition.

### Preparation Example 5

350 g of an acryl resin (SG-600TEA, weight average molecular weight of 1,200,000, glass transition temperature of −39° C., Nagase ChemTech Co., Ltd.), 20 g of a cresol novolac-based epoxy resin (YDCN-500-90P, molecular weight of 10,000 or less, Kukdo Chemical Co., Ltd.), 20 g of a cresol novolac-based curing agent (MEH-7800SS, Meiwa Plastic Industries Co., Ltd.), 1.5 g of an imidazole-based curing accelerator (2P4MZ, Sikoku Chemical Co., Ltd.), 1 g of an epoxy silane coupling agent (KBM-573, Shin Estu Chemical Co., Ltd.), and 30 g of a round silica filler (PLV-6XS, Tatsumori) were mixed and in turn subjected to primary dispersion at 700 rpm for 2 hours, followed by milling, thereby preparing an attach composition.

### Example 1 and Comparative Examples 1 to 3

### Preparation of Attach Film

The photocurable adhesive layer composition of Preparation Example 1 was coated on a polyethylene terephthalate (PET) film to form a coating, followed by laminating the coating and a polyolefin (PO) film to prepare a photocurable adhesive layer. Further, each of the insulation attach layer compositions of Preparation Examples 2 to 5 was coated on a PET film to form a coating, followed by laminating the coating and another PET film to prepare an insulation attach layer. Then, the prepared photocurable adhesive and the insulation attach layer were sequentially stacked using a laminator to prepare an attach film, which in turn was subjected to physical property testing.

### Example 1

The photocurable adhesive layer composition of Preparation Example 1 was coated on one side of a 38 μm PET release film (SRD-T38, Saehan Media Co., Ltd.) using an applicator and was then dried at 80° C. for 2 minutes to form a coating. The coating was then laminated on a 100 μm PO film at 60° C. and aged in an oven at 40° C. for 3 days to prepare a photocurable adhesive layer. Further, the insulation attach layer composition of Preparation Example 2 was coated to a thickness of 20 μm on one side of a 38 μm PET release film (SRD-T38, Saehan Media Co., Ltd.) using an applicator and was then dried at 80° C. for 2 minutes to form a coating. The coating was then laminated on a 38 μm PET (SRD-T38, Saehan Media Co., Ltd.) at 80° C. and aged at room temperature for 3 days to prepare an insulation attach layer. The prepared photocurable adhesive and the insulation attach layer were sequentially stacked using a laminator to prepare an attach film.

### Comparative Example 1

The insulation attach layer composition of Preparation Example 3 was coated to a thickness of 20 μm on one side of a 38 μm PET release film (SRD-T38, Saehan Media Co., Ltd.) using an applicator and was then dried at 80° C. for 2 minutes to form a coating. The coating was then laminated on a 38 μm PET release film (SRD-T38, Saehan Media Co., Ltd.) at 80° C. and aged at room temperature for 3 days to prepare an insulation attach layer. The attach film was prepared by the same method as in Example 1 except for the insulation attach layer.

### Comparative Example 2

The insulation attach layer composition of Preparation Example 4 was coated to a thickness of 20 μm on one side of a 38 μm PET release film (SRD-T38, Saehan Media Co., Ltd.) using an applicator and was then dried at 80° C. for 2 minutes to form a coating. The coating was then laminated on a 38 μm PET release film (SRD-T38, Saehan Media Co., Ltd.) at 80° C. and aged at room temperature for 3 days to prepare a high thermal resistance attach layer. The attach film was prepared by the same method as in Example 1 except for the insulation attach layer.

### Comparative Example 3

The insulation attach layer composition of Preparation Example 5 was coated to a thickness of 20 μm on one side of a 38 μm PET release film (SRD-T38, Saehan Media Co., Ltd.) using an applicator and was then dried at 80° C. for 2 minutes to form a coating. The coating was then laminated on a 38 μm PET release film (SRD-T38, Saehan Media Co., Ltd.) at 80° C. and aged at room temperature for 3 days to prepare a high thermal resistance attach layer. The attach film was prepared by the same method as in Example 1 except for the insulation attach layer.

Test: Property Evaluation of Attach Film

The properties of the attach films obtained in Example 1 and Comparative

### Examples 1 to 3 were evaluated. Results are shown in Table 2.

A detailed description of the test methods is given in the following.

(1) Melt Viscosity

To measure the melt viscosity of the attach films, each of the attach films was fabricated into a twenty-layer laminate and cut into a 8 mm-diameter circular specimens. The specimen had a thickness of 400 to 440 μm. The melt viscosity was measured while heating the specimen from 30° C. to 180° C. at a rate of 5° C./min with Axial force 200 gf, Strain 5%, Frequency 1 rad. Data at 175° C. was used to determine occurrence of voids under molding conditions. The melt viscosity was measured using a ARES (TA Instruments Co., Ltd.) with parallel plate and aluminum disposable plate(diameter 8 mm).

(2) Differential Scanning Calorimetry (DSC)

Each film sample was cut to a size having a mass of about 0.5 mg to prepare a cell specimen. The DSC was measured using a differential scanning calorimeter while heating the specimen from 30 to 350° C. at a rate of 10° C./min to obtain data of exothermic peak start temperature (° C.). A Q20 model differential scanning calorimeter (TA Instruments Co., Ltd.) was used for the measurement of DSC.

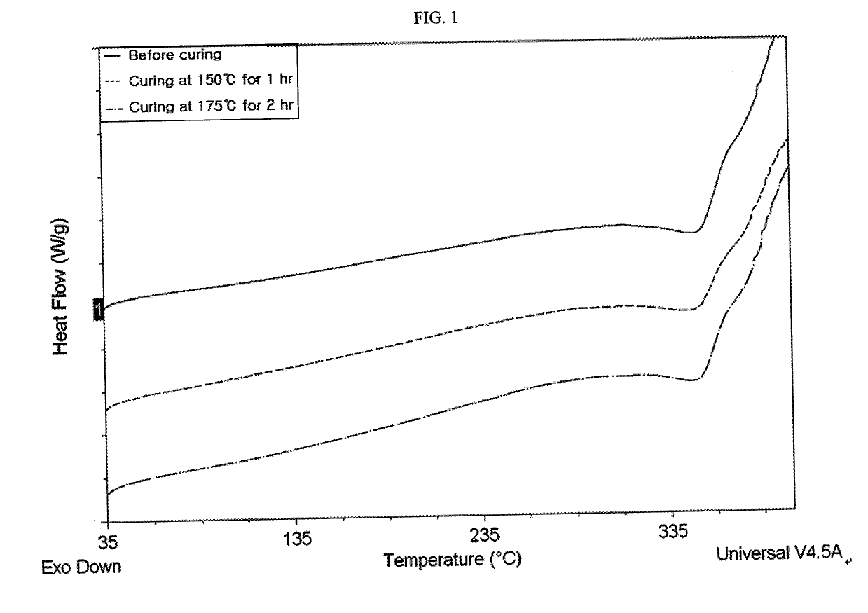

FIG. 1 shows curves of DSC variation of the attach film prepared in Example 1 before curing, after curing at 150° C. for 1 hr, and after curing at 175° C. for 2 hr, respectively. For all of the specimens, exothermic reaction started after 300° C., and it shows 50% or more of the curing residual ratio after curing at 150° C. for 1 hr or after curing at 175° C. for 2 hr. Consequently, void elimination may be easily carried out with high liquidity upon curing and molding.

(3) Storage Modulus

In each of the attach films prepared in Example 1 and Comparative Examples 1 to 3, the insulation attach layer was processed to a thickness of 200 μm and cut into a size of 7 mm×14 mm. Then, the storage modulus of the insulation attach layer was measured while heating the insulation attach layer from −10° C. to 150° C. at a rate of 4° C./min using a DMA Q800 (TA Instruments Co., Ltd.). Data at 175° C. was used to determine storage modulus.

(4) Measurement of 180-Degree Average Peel Strength Between Adhesive Layer and Insulation Attach Layer (Before and after UV Curing)

180 degree average peel strength between the adhesive layer and the insulation attach layer was tested in accordance with JIS Z0237. Each of the attach film specimens was cut to a size of 25 mm×150 mm after UV irradiation. Each specimen was peeled at an interface between the adhesive layer and the insulation attach layer using tweezers. Then, a portion of the specimen was clamped to upper and lower jigs in a 10 N load cell of a tensile tester (Instron Series 1×/s Automated materials Tester-3343) and peeled at a rate of 300 trim/min. Here, the load required for peeling was measured. UV irradiation was performed for 3 seconds using a high-pressure mercury lamp (DS-MUV 128-S1, Daesung Engineering Co., Ltd.) at a radiance of 70 W/cm² and an exposure dose of 300 mJ/cm². Ten specimens were measured before and after UV irradiation and averages were obtained.

(5) DSS (Die Shear Strength)

A 530 μm thick wafer coated with a dioxide film was cut into chips having a size of 5 mm×5 mm. The chips were laminated with each of the attach films at 60° C. The laminate was cut to leave behind a bonded portion only. With an upper chip (5×5 mm) placed on a lower chip (10×10 mm), the overlying chips were subjected to a load of 1 kgf on a hot plate at 120° C. for 1 sec to attach the chips to each other, and cured at 175° C. for 2 hours. The specimen was allowed to absorb moisture under PCT conditions for 8 hours, and reflowing was performed three times at a maximum temperature of 260° C. The die shear of the upper chip was measured at 100 μm/sec at 250° C.

(6) Void

Each of the attach films was laminated on a glass plate cut to 9×9 mm. With an upper chip (9×9 mm) placed on a lower chip (10×10 mm), the overlying chips were subjected to a load of 1 kgf on a hot plate at 150° C. for 1 sec to attach the chips to each other, and cured at 150° C. for 2 hours. The cured specimen was subjected to a force of 1 MPa at 150° C. for 15 seconds. The upper glass plate (9×9 mm) was then divided into 25 imaginary cells and void generation was evaluated in terms of the number of imaginary cells where voids were generated.

TABLE 2

| | | | | Comp. | Comp. | Comp. |
|---|---|---|---|---|---|---|
| Items | | Unit | Example 1 | Example 1 | Example 2 | Example 3 |
| Melt | Curing at | Poise | 1.2 × 10⁶ | 5.2 × 10⁶ | 6.3 × 10⁶ | 3.4 × 10⁶ |
| viscosity | 150° C. for 1 hr | | | | | |
| (175° C.) | Curing at | Poise | 2.3 × 10⁶ | 1.7 × 10⁷ | 2.6 × 10⁷ | 9.4 × 10⁷ |
| | 175° C. for 2 hr | | | | | |
| DSC (Start Temp) | | ° C. | 305 | 184 | 135 | 128 |
| Storage Modulus (175° C.) | | MPa | 1.65 | 3.76 | 4.25 | 4.68 |
| Peel strength | Before UV | (N/25 mm) | 1.27 | 1.68 | 0.95 | 1.42 |
| (adhesive layer- | After UV | | 0.06 | 0.09 | 0.05 | 0.09 |
| Insulation | | | | | | |
| attach layer) | | | | | | |

| | | | | | |
|---|---|---|---|---|---|
| Die Shear Strength | Kgf | 12 | 8 | 14 | 7 |
| Void | — | 0/25 | 7/25 | 12/25 | 16/25 |

As can be seen from Table 2, the attach film of Example 1 has an exothermic peak start temperature of 300° C. or more, which was much higher than those of the attach films of Comparative Examples 1 to 3, and has a melt viscosity in the range of 1.0×10⁵ to 5.0×10⁶ Poise. Further, the attach film of Example 1 has a storage modulus (175° C.) that is ⅓ to ½ those of the attach films of the comparative examples, thereby exhibiting suitable peel strength and die shear strength while facilitating superior void elimination. Consequently, the attach film of Example 1 exhibited characteristics desirable for superior void elimination ability, to permit stable wire bonding through improvement in adhesion to the base film, as compared to Comparative Examples 1 to 3.

Currently, the MCP has been increasingly demanded for high integration and high functionality of semiconductor memory beginning from flash memory embedded in cellular phones or mobile terminals. Further, when stacking multiple layers of chips, the current standard requires lamination of ultra-thin chips having a thickness of 100 μm or less so as to satisfy both size growth and thickness reduction of the multilayer chips. In the MCP technology, a film-like adhesive may be used, instead of liquid epoxy pastes, to bond a semiconductor chip to a semiconductor substrate. The liquid epoxy paste is inexpensive but may not prevent a semiconductor chip from being bent during a die-bonding process. In addition, the liquid epoxy paste may present problems such as difficulty in liquidity control, failure during wire bonding, difficulty in thickness control of an attach layer, void occurrence in the attach layer, etc.

In the wafer backside attach method, the film-like adhesive is adhered to the backside of a wafer and a dicing tape having an adhesive layer is then adhered to an opposite side of the attach film which is not bonded to the backside of the wafer, followed by dicing the wafer into individual chips. Then, the individual chips are picked-up and die bonded to a semiconductor substrate, followed by wire bonding and molding processes, thereby providing a semiconductor device. However, the wafer backside attach method may present problems such as difficulty in transporting thin-shaped wafers, process increase, difficulty in adapting to various chip thicknesses and sizes, difficulty in reducing the thickness of films, and low reliability when applied to highly functional semiconductor devices.

A method may include attachment to the backside of a wafer film having an adhesive and an adhesive in a single layer. This method may be achieved by performing a lamination process once, as opposed to performing the lamination process twice, and may avoid problems in transporting wafers by employing wafer rings for supporting the wafers. Furthermore, a UV curable adhesive and a thermally curable adhesive may be mixed in an integrated dicing die attach film composed of particular adhesive and adhesive compositions and a base. Therefore, the die attach film may serve as an adhesive to support a wafer in the dicing process and lose adhesive strength after ultraviolet curing, thereby allowing chips to be easily picked up from the wafer. Further, the die attach film may serve as an adhesive cured in the die bonding process, thereby securely attaching the chips to a semiconductor substrate. However, such an integrated dicing die attach film may present problems in that, if the adhesive strength of the film is not sufficiently lowered after UV curing, the base and the chips may not be easily separated from each other in the process of picking up semiconductor chips after dicing, thereby causing failure occurrence.

A separated type dicing die attach film having an adhesive layer and an attach layer separated from each other, which may be used as a dicing tape in the dicing process and may also be used as an attach film in the die bonding process, may be used instead. In the separated dicing die attach film, the adhesive layer and the attach layer may be easily separated from each other by UV-curing the film or by applying heat to the film after the dicing process, thereby avoiding problems with regard to the semiconductor chip during the pick-up process and providing convenience in that the film can be reduced in thickness during the die bonding process. Such a separated type dicing die attach film may have low storage modulus in order that an irregular surface of an organic wire board having a protruded circuit line on the surface thereof to be attached to chips can be sufficiently filled with the adhesive. However, the low storage modulus of such a film may make the film weak with respect to heat generated during dicing, resulting in burring of the film. Further, when such a film is subjected to a semi-curing process to prevent burring or delamination during wire bonding after die attach, the degree of crosslinking in the film may increases during this process, thereby causing void occurrence during molding and ultimately deteriorating reliability of the semiconductor package.

In view of the above noted constraints, embodiments may provide a highly reliable attach film composition for semiconductor assembly through regulation of exothermic peak start temperature during curing and melt viscosity after curing to facilitate elimination of voids and ensure wire bonding stability. Embodiments relate to highly reliable attach film compositions that may facilitate elimination of voids and ensure wire bonding stability by adjusting exothermic peak start temperature in curing reaction and viscosity after curing, as well as an attach film and an attach tape for semiconductor packaging using the same. The attach film composition may provide improved void elimination ability through improved adhesion to a base interface and permits stable wire bonding to achieve high reliability.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. An attach film composition for semiconductor assembly, the composition comprising:
a polymer binder;
an epoxy resin;
a phenolic epoxy curing agent;
a curing accelerator;
a silane coupling agent; and
an inorganic filler, wherein:
the attach film composition has an exothermic peak start temperature of about 300° C. or more in curing, and a melt viscosity of about 1.0×10⁵ to about 5.0×10⁶ Poise at 175° C. after curing at 150° C. for 1 hour and a melt viscosity of about 1.0×10⁵ to about 5.0×10⁶ Poise at 175° C. after curing at 175° C. for 2 hours.

2. The composition as claimed in claim 1, wherein the attach film composition comprises, based on 100 parts by weight of the polymer binder,
about 5 to about 30 parts by weight of the epoxy resin,
about 1 to about 30 parts by weight of the phenolic epoxy curing agent,
about 0.01 to about 10 parts by weight of the curing accelerator,
about 0.01 to about 10 parts by weight of the silane coupling agent, and
about 0.5 to about 20 parts by weight of the inorganic filler.

3. The composition as claimed in claim 1, wherein the polymer binder has a glass transition temperature of about −10° C. to about +20° C.

4. The composition as claimed in claim 1, wherein the polymer binder has a weight average molecular weight of about 50,000 to about 500,000 g/mol.

5. The composition as claimed in claim 1, wherein the polymer binder includes at least one of an epoxy group-containing (meth)acrylate copolymer containing glycidyl(meth)acrylate, a (meth)acryl resin, a polyimide resin, a polystyrene resin, a polyethylene resin, a polyester resin, a polyamide resin, a butadiene rubber, an acryl rubber, a urethane resin, a polyphenylene ether resin, a polyetherimide resin, a phenoxy resin, a polycarbonate resin, a polyphenylene ether resin, and a modified polyphenylene ether resin.

6. The composition as claimed in claim 1, wherein the epoxy resin includes at least one of a bisphenol-based epoxy resin, a phenol novolac-based epoxy resin, a cresol novolac-based epoxy resin, a polyfunctional epoxy resin, an amine-based epoxy resin, a heterocyclic epoxy resin, a substituted epoxy resin and a naphthol-based epoxy resin.

7. The composition as claimed in claim 1, wherein the phenolic epoxy curing agent includes a phenol-p-xyleneglycoldimethylether polycondensate-based curing agent.

8. The composition as claimed in claim 1, wherein the inorganic filler includes at least one of gold in powder form, silver in powder form, copper in powder form, nickel in powder form, alumina, aluminum hydroxide, magnesium hydroxide, calcium carbonate, magnesium carbonate, calcium silicate, magnesium silicate, calcium oxide, magnesium oxide, aluminum oxide, aluminum nitride, silica, boron nitride, titanium dioxide, glass, ferrite, and ceramic.

9. The composition as claimed in claim 1, wherein the curing accelerator includes at least one of a melamine-based curing accelerator, an imidazole-based curing accelerator, and a triphenylphosphine-based curing accelerator.

10. The composition as claimed in claim 1, wherein the silane coupling agent includes at least one of an epoxy-containing silane coupling agent, an amine group-containing silane agent, a mercapto-containing silane agent, and an isocyanate-containing silane agent.

11. The composition as claimed in claim 10, wherein the silane coupling agent includes the epoxy-containing silane coupling agent, the epoxy-containing silane coupling agent including at least one of 2-(3,4-epoxycyclohexyl)-ethyltrimethoxysilane, 3-glycidoxytrimethoxysilane, and 3-glycidoxypropyl triethoxysilane.

12. The composition as claimed in claim 10, wherein the silane coupling agent includes the amine group-containing silane agent, the amine group-containing silane agent including at least one of N-2(aminoethyl)-3-aminopropyl methyldimethoxysilane, N-2(aminoethyl)-3-aminopropyltrimethoxysilane, N-2(aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine, and N-phenyl-3-aminopropyltrimethoxysilane.

13. The composition as claimed in claim 10, wherein the silane coupling agent includes the mercapto-containing silane agent, the mercapto-containing silane agent including at least one of 3-mercaptopropylmethyl dimethoxysilane and 3-mercaptopropyltriethoxysilane.

14. The composition as claimed in claim 10, wherein the silane coupling agent includes the isocyanate-containing silane agent, the isocyanate-containing silane agent including 3-isocyanate propyltriethoxysilane.

15. An attach film for semiconductor assembly formed of the composition as claimed in claim 1.

16. An attach tape for semiconductor packaging, comprising:
a base film;
a UV curable adhesive film;
the attach film as claimed in claim 15; and
a protective film.

17. An attach film composition for semiconductor assembly, the composition comprising:
an acrylic polymer binder, the acrylic polymer binder having a glass transition temperature of about −10° C. to about +20° C. and having a weight average molecular weight of about 50,000 to about 500,000 g/mol;
a bisphenol-A-based epoxy resin having a molecular weight of about 10,000 or less;
a polymeric curing agent including a polymeric backbone corresponding to a polymer of phenol with 1,4-bis(methoxymethyl)benzene;
a curing accelerator;
a silane coupling agent; and
an inorganic filler.
